(19) United States
(12) Patent Application Publication
(10) Pub. No.: US 2013/0028535 A1
(43) Pub. Date: Jan. 31, 2013

(54) Image Scanning Apparatus

(71) Applicant: Hironori Yamauchi, Osaka (JP)

(72) Inventor: Hironori Yamauchi, Osaka (JP)

(73) Assignee: Kyocera Document Solutions, Inc.

(21) Appl. No.: 13/538,549

(22) Filed: Jun. 29, 2012

(30) Foreign Application Priority Data
Jul. 26, 2011 (JP) 2011-163617

(51) Int. Cl. H04N 1/04; G06K 9/40

(52) U.S. Cl. 382/274; 358/474

(57) ABSTRACT

An image scanning apparatus according to this disclosure, includes: a reference data acquiring unit configured to acquire reference data to be used for shading correction as integer data; a short-bit-length data generating unit configured to generate short-bit-length data from the reference data, a bit-length of the short-bit-length data being shorter than a bit-length of the reference data acquired by the reference data acquiring unit; and a memory that the short-bit-length data is stored in. The short-bit-length data generating unit is further configured to generate the short-bit-length data which has a value obtained by subtracting a value of offset data from a value of the reference data. The value of the offset data is a predetermined value lower than an estimated minimum value of the reference data acquired by the reference data acquiring unit.

### CROSS-REFERENCE TO RELATED APPLICATIONS

This application relates to and claims priority rights from Japanese Patent Application No. 2011-163617, filed on Jul. 26, 2011, the entire disclosures of which are hereby incorporated by reference herein.

### BACKGROUND OF THE INVENTION

1. Field of the Invention

The present invention relates to image scanning apparatuses.

2. Description of the Related Art

An image scanning apparatus such as scanner often performs shading correction for a document image in order to prevent from dropping in scanned image quality due to ununiformity of a light intensity from a light source lamp, ununiformity of sensitivity of an image sensor, and so forth.

In the shading correction, image data of a document image is corrected on the basis of quantized white reference data and black reference data. Since the white reference data and the black reference data are quantized data, the longer the bit lengths of the white reference data and the black reference data are, the more precise the shading correction is.

However, the longer the bit lengths of the white reference data and the black reference data are, the larger the size of a memory area required to store the data is. Therefore, for example, in a technique, short-bit-length data are obtained by reducing bits which have a little effect on precision from all bits of white reference data and black reference data as real-number data, and the short-bit-length data are stored instead of the white reference data and the black reference data themselves. Consequently, the size of a memory area required to store the white reference data and the black reference data is small.

In the aforementioned technique, although the size of a memory area for the white reference data and the black reference data is small, the precision of the shading correction is low due to the lack of some bits which express a numerical value.

Further, since the aforementioned technique requires real number operations to handle the white reference data and the black reference data, the shading correction spends a lot of time, especially in low performance machines.

### SUMMARY OF THE INVENTION

An image scanning apparatus according to an aspect of this disclosure, includes: a reference data acquiring unit configured to acquire reference data to be used for shading correction as integer data; a short-bit-length data generating unit configured to generate short-bit-length data from the reference data, a bit-length of the short-bit-length data being shorter than a bit-length of the reference data acquired by the reference data acquiring unit; and a memory that the short-bit-length data is stored in. The short-bit-length data generating unit is further configured to generate the short-bit-length data which has a value obtained by subtracting a value of offset data from a value of the reference data. The value of the offset data is a predetermined value lower than an estimated minimum value of the reference data acquired by the reference data acquiring unit.

Therefore, due to the integer data, shading correction is performed in a reasonable time without dropping in precision, and a small memory area is sufficient to store the short-bit-length data rather than the reference data itself.

These and other objects, features and advantages of the present invention will become more apparent upon reading of the following detailed description along with the accompanied drawings.

### BRIEF DESCRIPTION OF THE DRAWINGS

FIG. 1 shows a side view of an internal configuration of an image scanning apparatus in this disclosure;

FIG. 2 shows a block diagram which indicates an electronic configuration of the image scanning apparatus in this disclosure;

FIG. 3 shows a flowchart which explains a process to store short-bit-length data as white reference data and black reference data in the image scanning apparatus of this disclosure;

FIG. 4 shows a diagram which indicates an example of the black reference data and an example of the short-bit-length data obtained from the black reference data; and

FIG. 5 shows a diagram which indicates an example of the white reference data and an example of the short-bit-length data obtained from the white reference data.

### DETAILED DESCRIPTION

Hereinafter, embodiments according to aspects of the present disclosure will be explained with reference to drawings.

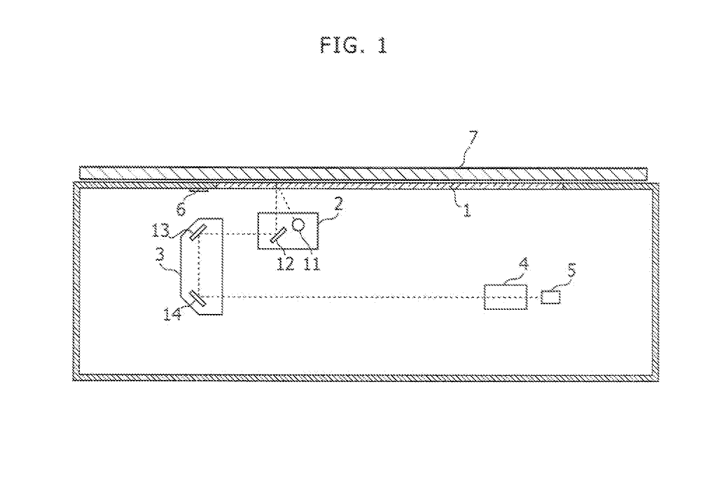

FIG. 1 shows a side view of an internal configuration of an image scanning apparatus in this disclosure. The image scanning apparatus shown in FIG. 1 is an apparatus such as scanner, copier, or multi-function peripheral.

In FIG. 1, a contact glass 1 is disposed on a top surface of a body of the image scanning apparatus, and a document is put on the contact glass 1 when a document image is scanned from the document.

A carriage 2 is capable of moving in the secondary scanning direction with an unshown driving source. The carriage 2 includes a light source 11 and a mirror 12. The light source 11 is arranged along the primary scanning direction, and emits light, for example, with pluralities of aligned light emitting diodes. The light emitted from the light source 11 reflects at positions corresponding to a position of the carriage 2, such as a document on the contact glass 1, a white reference patch 6 (mentioned below), and so forth. The mirror 12 reflects the reflection light from the document, the white reference patch 6 (mentioned below), and so forth.

Further, the carriage 3 is capable of moving together with the carriage 2 in the secondary scanning direction with an unshown driving source. The carriage 3 includes mirrors 13 and 14. The mirrors 13 and 14 reflects light from the mirror 12 of the carriage 2, and outputs the light in the secondary scanning direction.

An imaging lens 4 focuses the light from the mirror 14 on an image sensor 5.

The image sensor 5 is a one-dimensional image sensor which includes light sensing elements corresponding to the predetermined number of pixels aligned in the primary scanning direction, and outputs electronic signals which indicate respective amounts sensed on the pixels line by line. For example, the image sensor 5 may be a CCD (Charge Coupled Device).

The white reference patch 6, disposed on a ceiling surface inside of the apparatus, is a plate-shaped unit used to acquire white reference data.

A document cover 7 is a substantially flat-plate-shaped unit capable of contacting a surface area of the contact glass 1 when it rotates, and presses a document against the contact glass 1 and prevents environmental light from entering through the contact glass 1 to the inside of the apparatus during image scanning.

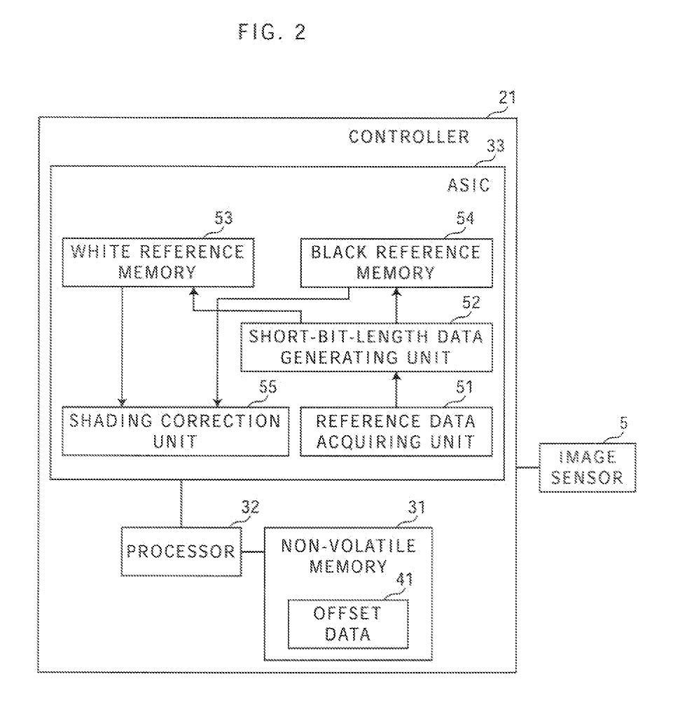

FIG. 2 shows a block diagram which indicates an electronic configuration of the image scanning apparatus in this disclosure.

In FIG. 2, a controller 21 is a circuit which performs arithmetic processing, control of an unshown driving source in the apparatus, and so forth. The controller 21 controls the unshown driving source to move the carriages 2 and 3, acquires reference data (the black reference data and the white reference data) for shading correction from the output of the image sensor 5, acquires image data when image scanning, and performs the shading correction. Since the output of the image sensor 5 is analog signals, an unshown A/D converter converts it to digital signals, and the output of the image sensor 5 is inputted as digital signals into the controller 21.

The controller 21 includes a non-volatile memory 31, a processor 32, and an ASIC (Application Specific Integrated Circuit) 33.

In the non-volatile memory 31 such as EEPROM (Electrically Erasable Programmable Read-Only Memory), offset data 41, other data, and a control program have been stored, and in the control program, operations of the controller 21 are described.

The offset data 41 includes an offset value on the black reference and an offset value on the white reference. The offset data 41 is data used to convert the reference data to short-bit-length data.

The processor 32 such as CPU (Central Processing Unit) causes, the ASIC 33 to perform processes in accordance with the control program.

The ASIC 33 is an image processing circuit which performs a process such as shading correction for image data obtained from the output of the image sensor 5. The ASIC 33 is a single IC chip. The ASIC 33 includes a reference data acquiring unit 51, a short-bit-length data generating unit 52, a white reference memory 53, a black reference memory 54, and a shading correction unit 55.

The reference data acquiring unit 51 acquires reference data to be used for shading correction as integer data from an output value of the image sensor 5. In this embodiment, the reference data acquiring unit 51 acquires black reference data and white reference data as the reference data. The bit lengths of the black reference data and the white reference data are set according to precision required of the shading correction.

The short-bit-length data generating unit 52 generates short-bit-length data from the reference data acquired by the reference data acquiring unit 51. The bit-length of the short-bit-length data is shorter than the bit-length of the reference data acquired by the reference data acquiring unit 51.

Specifically, the short-bit-length data generating unit 52 generates the short-bit-length data which has a value obtained by subtracting a value of offset data from a value of the reference data. The value of the offset data 41 is a predetermined value lower than an estimated minimum value of the reference data acquired by the reference data acquiring unit 51. The estimated minimum value of the reference data is the lowermost value in an estimated range of values of the reference data acquired by the reference data acquiring unit 51. The estimated range is a range with a predetermined width which includes a target value of the reference data. For example, this width is set on the basis of a standard deviation of errors from the target value, and the standard deviation can be obtained in some experiments.

The bit length of the short-bit-length data is set in accordance with the value of the offset data 41 and an estimated range of values of the reference data acquired by the reference data acquiring unit 51. For example, if the value of the offset data 41 is 31 and the upper most value of the estimated range is 50, then the difference between the upper most value of the estimated range and the value of the offset data 41 is 19. Therefore, to enable the short-bit-length data to express the value “19”, the bit length of the short-bit-length data is set as 5 bits.

The white reference memory 53 is a memory in which short-bit-length data obtained from the white reference data is stored. Therefore, the size obtained in bit by multiplying the number of pixels in a line obtained from the image sensor 5 by the bit length of the short-bit-length data obtained from the white reference data is enough for the memory area size of the white reference memory 53. Consequently, the memory area size of the white reference memory 53 is smaller than a memory area size required to store the white reference data itself of a line obtained from the image sensor 5.

The black reference memory 54 is a memory in which short-bit-length data obtained from the black reference data is stored. Therefore, the size obtained in bit by multiplying the number of pixels in a line obtained from the image sensor 5 by the bit length of the short-bit-length data obtained from the black reference data is enough for the memory area size of the black reference memory 54. Consequently, the memory area size of the black reference memory 54 is smaller than a memory area size required to store the black reference data itself of a line obtained from the image sensor 5.

In this embodiment, for example, SRAMs (Static Random Access Memory) are used as the white reference memory 53 and the black reference memory 54.

The shading correction unit 55 reads out the short-bit-length data from the white reference memory 53 and the black reference memory 54, and performs the shading correction on the basis of the short-bit-length data and the offset data for image data obtained from the output of the image sensor 5 when scanning a document image.

Specifically, the shading correction unit 55 restores the value of the reference data by adding the value of the offset data to the value of the short-bit-length data, and performs the shading correction using the restored value of the reference data.

In the following part, a behavior of the aforementioned image scanning apparatus is explained.

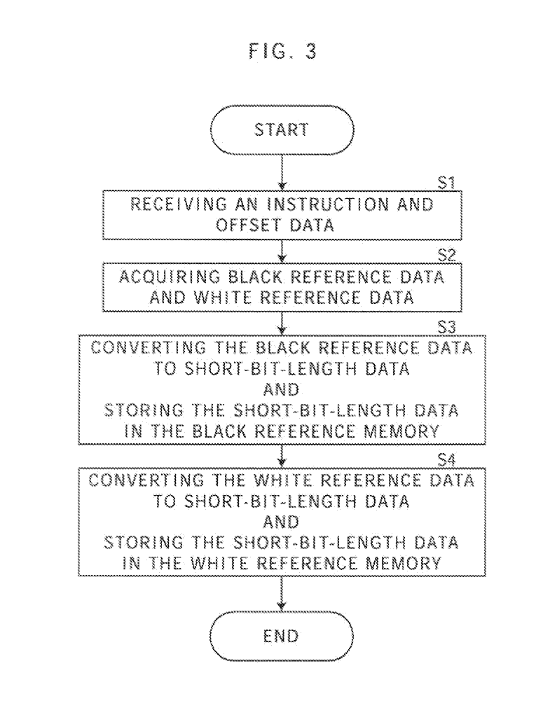

At first, the process to store the short-bit-length data as the white reference data and the black reference data is explained. FIG. 3 shows a flowchart which explains a process to store the short-bit-length data as the white reference data and the black reference data in the image scanning apparatus of this disclosure.

According to an instruction from the processor 32, the ASIC 33 of the controller 21 starts the process to store the short-bit-length data as the white reference data and the black reference data (Step S1). The processor 32 reads out the offset data 41 from the non-volatile memory 31, and provides it to the ASIC 33.

In the ASIC 33, the reference data acquiring unit 51 firstly acquires black reference data of a line from an output value of the image sensor 5 while keeping the light source 11 off, and secondly sets the carriages 2 and 3 at a measurement position for the white reference patch 6 and acquires white reference data of a line from an output value of the image sensor 5 while keeping the light source 11 on (Step S2).

These white reference data and black reference data are temporary stored in an unshown RAM inside of the ASIC 33, but deleted from the RAM after the short-bit-length data mentioned below are stored in the white reference memory 53 and the black reference memory 54.

It should be noted that the reference data acquiring unit 51 may acquire the black reference data of a line from an average value obtained by calculating an average value on each of pixels over plural lines of output values from the image sensor 5. In the same way, the reference data acquiring unit 51 may acquire the white reference data of a line from an average value obtained by calculating an average value on each of pixels over plural lines of output values from the image sensor 5.

The short-bit-length data generating unit 52 converts the black reference data acquired by the reference data acquiring unit 51 to short-bit-length data, and stores the short-bit-length data in the black reference memory 54 (Step S3). The short-bit-length data generating unit 52 also converts the white reference data acquired by the reference data acquiring unit 51 to short-bit-length data, and stores the short-bit-length data in the white reference memory 53 (Step S4). Step S3 and Step S4 may be performed in the reverse order, and may be performed in parallel.

Specifically, regarding each of pixels in a line, the shot-bit-length data generating unit 52 subtracts an offset value for black reference in the offset data 41 from a pixel value of the pixel in the black reference data, and sets the subtraction result to a value on the pixel in the short-bit-length data for black reference. In the same way, regarding each of pixels in a line, the shot-bit-length data generating unit 52 subtracts an offset value for white reference in the offset data 41 from a pixel value of the pixel in the white reference data, and sets the subtraction result to a value on the pixel in the short-bit-length data for white reference.

For example, if the target value of the black reference data is 45 and the estimated range of values of the black reference data acquired by the reference data acquiring unit 51 is from 40 to 50, then the black reference data is integer data of 6 bits, and the offset value for black reference is set as 31, for example. In this case, the offset value for black reference has been stored as 1-byte data in the offset data 41 in the non-volatile memory 31.

Further, in this case, since the value of the offset data 41 is 31, and the uppermost value of the estimated range is 50, the difference between the uppermost value of the estimated range and the value of the offset data 41 is 19. Therefore, to enable the short-bit-length data for black reference to express the value “19”, the bit length of the short-bit-length data for black reference is set as 5 bits.

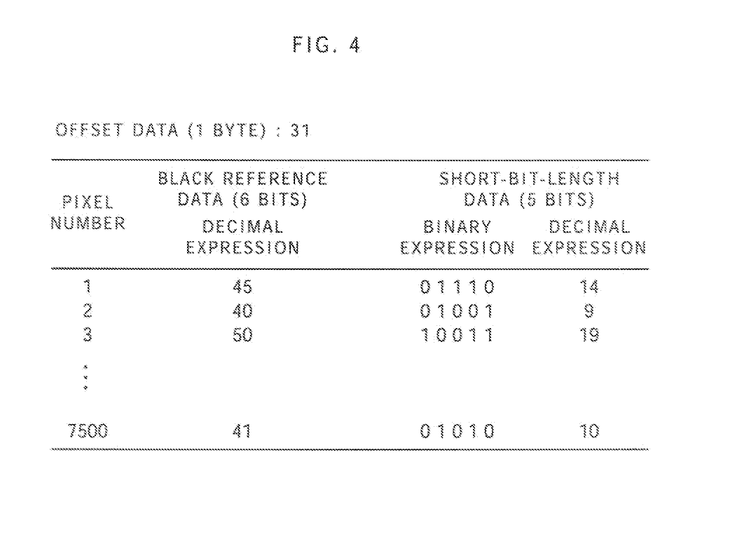

FIG. 4 shows a diagram which indicates an example of the black reference data and an example of the short-bit-length data obtained from the black reference data.

If the number of pixels in a line of the image sensor 5 is 7500, then as shown in FIG. 4, the black reference data is 7500 values of 6 bits, and the short-bit-length data is 7500 values of 5 bits.

Therefore, in this case, the size of a memory area required to the black reference memory 54 is 37,500 bits (=7500×5), and namely, smaller than the memory area size (45,000 bits) required to store the black reference data itself.

Further, for example, if the target value of the white reference data is 900 and the estimated range of the white reference data acquired by the reference data acquiring unit 51 is from 800 to 1000, then the white reference data is integer data of 10 bits, and the offset value for white reference is set as 511, for example. In this case, the offset value for white reference has been stored as 2-byte data in the offset data 41 in the non-volatile memory 31. If the offset value for white reference is equal to or larger than 256, then the offset value for white reference is 16-bit data, and a value of the upper 8 bits and a value of the lower 8 bits are stored as 2-byte data in the non-volatile memory 31.

Further, in this case, since the value of the offset data 41 is 511, and the uppermost value of the estimated range is 1000, the difference between the uppermost value of the estimated range and the value of the offset data 41 is 489. Therefore, to enable the short-bit-length data for white reference to express the value “489”, the bit length of the short-bit-length data for white reference is set as 9 bits.

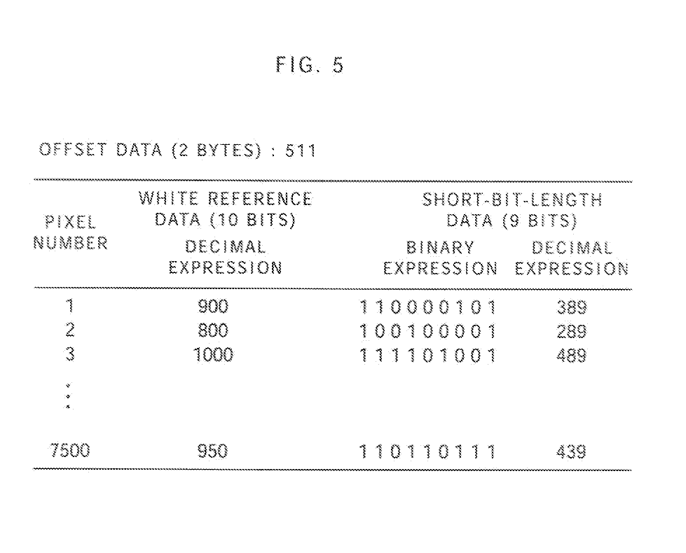

FIG. 5 shows a diagram which indicates an example of the white reference data and an example of the short-bit-length data obtained from the white reference data.

If the number of pixels in a line of the image sensor 5 is 7500, then as shown in FIG. 5, the white reference data is 7500 values of 10 bits, and the short-bit-length data is 7500 values of 9 bits.

Therefore, in this case, the size of a memory area required to the white reference memory 53 is 67,500 bits (=7500×9), and namely, smaller than the memory area size (75,000 bits) required to store the white reference data itself.

In the following part, the shading correction process using the short-bit-length data stored in the white reference data 53 and the black reference data 54 is explained.

Upon receiving a scan instruction by a user operation from an unshown operation unit or upon receiving a scan instruction received by an unshown communication device from an unshown host device, the processor 32 of the controller 21 causes the ASIC 33 to update the reference data, and then starts a document scan operation.

The ASIC 33 acquires the white reference data and the black reference data in the aforementioned manner, and updates the short-bit-length data in the white reference memory 53 and the black reference memory 54 with the short-bit-length data obtained from the acquired white reference data and the acquired black reference data.

After updating the short-bit-length data, the ASIC 33 of the controller 21 starts a document scan operation, and acquires image data of each line from the output of the image sensor 5 while moving the carriages 2 and 3 in the secondary scanning direction.

The shading correction unit 55 performs the shading correction for a value of each pixel in each line.

Specifically, the shading correction unit 55 performs the shading correction according to the next formula using the offset data 41 provided from the processor 32 and the short-bit-length data stored in the white reference memory 53 and the black reference memory 54.

(corrected pixel value)=[(pixel value before correction)−{(value of short-bit-length data for black reference)+(offset value for black reference)}]/[{(value of short-bit-length data for white reference)+(offset value for white reference)}−{(value of short-bit-length data for black reference)+(offset value for black reference)}]

In this formula, the value of short-bit-length data for black reference, the value of short-bit-length data for white reference, and the offset values are values on a pixel to which the shading correction is applied.

In the aforementioned embodiment, the reference data acquiring unit 51 acquires white reference data and black reference data to be used for shading correction as integer data. The short-bit-length data generating unit 52 generates respective short-bit-length data from the white reference data and the black reference data, and stores the respective short-bit-length data in the white reference memory 53 and the black reference memory 54, respectively. The bit-lengths of the respective short-bit-length data are shorter than the bit-lengths of the white reference data and the black reference data, respectively. The short-bit-length data generating unit 52 generates the short-bit-length data which has a value obtained by subtracting an offset value from a value of the reference data. Each offset value is set as a predetermined value lower than the estimated minimum value of the reference data acquired by the reference data acquiring unit 51.

Therefore, due to the integer data, shading correction is performed in a reasonable time without dropping in precision, and a small memory area is sufficient to store the short-bit-length data rather than the reference data itself.

The description of the present invention has been presented for purposes of illustration and description, and is not intended to be exhaustive or limited to the invention in the form disclosed.

For example, in the aforementioned embodiment, if reference data having a value lower than the offset value of the offset data 41 is acquired, then the value of the offset data 41 may be changed to the value lower than the offset value, and the short-bit-length data may be generated from the reference data on the basis of the updated offset data 41.

Further, in the aforementioned embodiment, the short-bit-length data of the black reference data and the short-bit-length data of the white reference data are generated and stored after acquiring the black reference data and the white reference data is finished. Alternatively, upon acquiring one of the black reference data and the white reference data, the short-bit-length data of the acquired reference data may be generated and stored; and the acquired reference data may be deleted in the ASIC 33; and after the acquired reference data is deleted, the short-bit-length data of the other of the black reference data and the white reference data may be generated and stored.

Furthermore, although both of the black reference data and the white reference data are stored as the offset data and the short-bit-length data in the aforementioned embodiment, only one of the black reference data and the white reference data may be stored as the offset data 41 and the short-bit-length data.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image scanning apparatus, comprising:
a reference data acquiring unit configured to acquire reference data to be used for shading correction as integer data;
a short-bit-length data generating unit configured to generate short-bit-length data from the reference data, a bit-length of the short-bit-length data being shorter than a bit-length of the reference data acquired by the reference data acquiring unit; and
a memory that the short-bit-length data is stored in;
wherein the short-bit-length data generating unit is further configured to generate the short-bit-length data which has a value obtained by subtracting a value of offset data from a value of the reference data; and
the value of the offset data is a predetermined value lower than an estimated minimum value of the reference data acquired by the reference data acquiring unit.

2. The image scanning apparatus according to claim 1, further comprising:
a shading correction unit configured to read out the short-bit-length data from the memory and perform the shading correction for image data on the basis of the short-bit-length data and the offset data.

3. The image scanning apparatus according to claim 2, wherein:
the shading correction unit is further configured to restore the value of the reference data by adding the value of the offset data to the value of the short-bit-length data, and perform the shading correction using the restored value of the reference data.

4. The image scanning apparatus according to claim 2, wherein:
the short-bit-length data generating unit, the memory, and the shading correction unit are disposed in a single IC chip; and
the offset data is stored in a non-volatile memory other than the IC chip, and supplied from the non-volatile memory to the short-bit-length data generating unit and the shading correction unit inside of the IC chip.

5. The image scanning apparatus according to claim 3, wherein:
the short-bit-length data generating unit, the memory, and the shading correction unit are disposed in a single IC chip; and
the offset data is stored in a non-volatile memory other than the IC chip, and supplied from the non-volatile memory to the short-bit-length data generating unit and the shading correction unit inside of the IC chip.

6. The image scanning apparatus according to claim 1, wherein:
the estimated minimum value of the reference data is a lowermost value in an estimated range of values of the reference data acquired by the reference data acquiring unit, and the estimated range is a range with a predetermined width which includes a target value of the reference data.

7. The image scanning apparatus according to claim 1, wherein:
the bit length of the short-bit-length data is set in accordance with the value of the offset data and an estimated range of values of the reference data acquired by the reference data acquiring unit.

8. The image scanning apparatus according to claim 1, wherein:
the reference data is white reference data and/or black reference data.
